(19) United States
(12) Patent Application Publication
(10) Pub. No.: US 2011/0259965 A1
(43) Pub. Date: Oct. 27, 2011

(54) HIGH PERFORMANCE GLASS TRANSPONDER

(75) Inventor: Ezequiel Mejia, Woodbury, MN (US)

(73) Assignee: RFID SOLUTIONS S.L., Campanillas (Malaga) (ES)

(21) Appl. No.: 13/095,075

(22) Filed: Apr. 27, 2011

Related U.S. Application Data
(60) Provisional application No. 61/328,270, filed on Apr. 27, 2010.

(51) Int. Cl. G06K 19/077

(52) U.S. Cl. 235/492

(57) ABSTRACT

A magnetic antenna core for use in an implantable passive radio-frequency identification tag. The magnetic antenna core can be ferrite or similar material and can be rectangular, planar, circular, or semi-circular along the length of the core. The magnetic antenna core does not have any constraints to mount an antenna coil in a particular orientation and electronics can be mounted on either side of either end of the antenna core, or on the end face parallel to the extreme sides of the antenna core.

### CROSS-REFERENCE TO RELATED APPLICATIONS

This Application is a non-provisional of and claims the benefit of the filing date of U.S. Provisional Application No. 61/328,270, filed Apr. 27, 2010, entitled “High Performance Glass Transponder,” the entire contents of which is incorporated herein by reference.

### FIELD OF THE INVENTION

This application generally relates to the field of passive radio frequency identification tags, also called passive integrated transponders. Particularly, embodiments of the present invention relate to a passive radio frequency identification tag having a unitary or one-piece magnetic antenna core.

### BACKGROUND

Radio-frequency identification (“RFID”) is the use of an object (typically referred to as a passive integrated transponder (“PIT”) or RFID tag) applied to or incorporated into a product, animal or person for the purpose of identification and tracking using radio waves. Some tags can be read from several meters away depending on the tag and reader antenna size for passive types and from greater distances for active types.

Radio-frequency identification comprises interrogators (also known as readers) and tags (also known as labels). Most RFID tags contain at least two parts. One is an integrated circuit for storing and processing information, modulating and demodulating a radio-frequency (RF) signal, and other specialized functions. The second is an antenna for receiving and transmitting the signal.

There are generally three types of RFID tags: active RFID tags, which contain a battery and can transmit signals autonomously, passive RFID tags, which have no battery and require an external source to provoke signal transmission, and battery assisted passive (BAP) RFID tags, which require an external source to wake up but have significantly higher forward link capability providing greater range.

RFID tags have many applications; for example, RFID tags are used in enterprise supply chain management, retail sales monitoring and management, transportation payments, and animal identification and management to improve the efficiency of inventory tracking and management. RFID tags for animal identification and management are typically an implantable variety of passive RFID tag. These RFID tags are more well-known as “chips” on animals.

Existing high performance passive RFID tags in the size of 14 mm long or smaller, used mainly for identifying companion animals, fish, wildlife and slaughter animals, have special antenna ferrites, designed mainly with one antenna side dedicated exclusively to mount the electronics. At this side the ferrite is has an elongated flattened portion that is metalized. The integrated circuit is typically electrically connected to the antenna leads by terminating the antenna leads to the metallization layers and attaching the integrated circuit to the metallization layers using a flip-chip type connection. Flip-chip is a method for interconnecting semiconductor devices, such as IC chips and Micro-electro-mechanical systems, to external circuitry with solder bumps (or gold bumps) having been deposited onto the chip pads. The solder bumps are deposited on the chip pads on the top side of the wafer during the final wafer processing step. In order to mount the chip to external circuitry (e.g., a circuit board or another chip or wafer), it is flipped over so its top side faces down, and aligned so its pads align with matching pads on the external circuit, and then the solder is flowed to complete the interconnect. This is in contrast to wire bonding, in which the chip is mounted upright and wires are used to interconnect the chip pads to external circuitry.

Current antenna ferrites require the ferrite to be metalized for connecting the antenna coil and integrated circuit, and require orienting the antenna ferrite in a particular direction for mounting and connecting the antenna coil and integrated circuit. It would be desirable to have an antenna core for an RFID tag that does not require metalization. It would also be desirable to provide an antenna core that does not require flip-chip mounting for the integrated circuit. It would also be desirable to provide an antenna core that does not have a requirement to orient the antenna in a single direction for mounting and connecting the antenna coil.

### SUMMARY

Embodiments of the present invention include an RFID passive glass or similar implantable transponder, generally in the size of 12-14 mm long, but possibly within 8-10 mm long and within 4-5 mm long with a diameter usually in the range of 2-10 mm, but possibly within the range of 2-7 mm and possibly within the range of 1-5 mm. The transponder could be operated at the frequency of 134.2 KHz to 125 KHz, used generally for identifying of companion animals, fish, wildlife and slaughter animals.

An antenna assembly of the RFID tag or transponder can be composed in two parts: antenna and electronics (e.g., die and/or module) with the following characteristics: the antenna core can be ferrite or similar material and can be either rectangular, planar or circular along the length or semi circular along two sides; the electronics mounted on either side of the antenna or only at one side; the electronics (e.g., module or die) can be placed or attached to the antenna along the length axis; and the electronics (e.g., module or die) can be mounted parallel to extreme sides of the antenna.

According to one aspect consistent with various embodiments a passive radio-frequency identification tag comprises a magnetic core having a longitudinal axis, the magnetic core elongated along the longitudinal axis and including a first end section at one end of the magnetic core, a central section, and a second end section at an opposite end of the magnetic core from the first end section, the first and second end sections having substantially equal lengths along the longitudinal axis of the magnetic core and greater cross-sectional area than a cross-sectional area of the central section, wherein the first and second end sections each have arcuate sides and substantially planar top and bottom surfaces, an integrated circuit disposed on one of the top or the bottom surfaces of one of the first or second end sections; and an antenna coil formed around the central section and coupled to the integrated circuit.

According to other aspects consistent with various embodiments the passive radio-frequency identification tag may have a central section that has substantially planar top and bottom surfaces and sides that comprise circular arcs. The end sections may also have sides that comprise circular arcs. The magnetic core may comprise ferrite or high-temperature ferrite. The leads of the antenna coil may be directly connected to the integrated circuit, for example, using thermal compression bonding. The magnetic core may have a height that is substantially uniform along the longitudinal axis of the core. The integrated circuit may be attached to the one of the top or bottom surfaces of the one of the first or second end sections using an epoxy. The radio-frequency identification tag may also include an encapsulation housing that surrounds the magnetic core, for example, a glass encapsulation housing.

According to other aspects consistent with various embodiments a passive radio frequency identification tag comprises a magnetic core having a longitudinal axis, the magnetic core elongated along the longitudinal axis and symmetric about a vertical axis passing through a center of the magnetic core and orthogonal to the longitudinal axis, the magnetic core including a central section and first and second end sections having greater cross-sectional area than the central section, wherein the first and second end sections each have arcuate sides and substantially planar top and bottom surfaces, an integrated circuit disposed on one of the top or bottom surfaces of one of the first or second end sections, and an antenna coil formed around the central section and electrically coupled to the integrated circuit. The first and second end sections each may have substantially planar surfaces at the ends of the magnetic core and orthogonal to the longitudinal axis.

According to other aspects consistent with various embodiments a passive radio-frequency identification tag comprises a magnetic core having a longitudinal axis, the magnetic core elongated along the longitudinal axis and including a first end section at one end of the magnetic core, a central section, and a second end section at an opposite end of the magnetic core from the first end section, the first and second end sections having substantially equal lengths along the longitudinal axis of the magnetic core and greater cross-sectional area than a cross-sectional area of the central section, wherein the first and second end sections each have substantially planar surfaces at the ends of the magnetic core and orthogonal to the longitudinal axis, an integrated circuit disposed on one of the substantially planer surfaces of the first and second end sections, and an antenna coil fowled around the central section and electrically coupled to the integrated circuit. The central section of the magnetic core may have substantially planar top and bottom surfaces and arcuate sides. Alternatively, the central section of the magnetic core may have a circular cross-section. The first and second end sections may have substantially planar top and bottom surfaces and arcuate sides.

### BRIEF DESCRIPTION OF THE DRAWINGS

Embodiments of the present invention are illustrated in referenced figures of the drawings. It is intended that the embodiments and figures disclosed herein be considered illustrative rather than limiting.

FIG. 1 illustrates an isometric elevated view of components of an implantable passive radio-frequency identification tag.

FIG. 2a depicts a top view of an antenna core for a passive radio-frequency identification tag.

FIG. 2b depicts a side view of an antenna core for a passive radio-frequency identification tag.

FIG. 2c depicts an end view of an antenna core for a passive radio-frequency identification tag.

FIG. 3a depicts a top view of an antenna core for a passive radio-frequency identification tag.

FIG. 3b depicts a side view of an antenna core for a passive radio-frequency identification tag.

FIG. 3c depicts an end view of an antenna core for a passive radio-frequency identification tag.

FIG. 4a depicts a top view of a passive radio-frequency identification tag employing the core illustrated in FIGS. 2a-2c.

FIG. 4b depicts a side view of a passive radio-frequency identification tag employing the core illustrated in FIGS. 2a-2c.

FIG. 4c depicts an end view of a passive radio-frequency identification tag employing the core illustrated in FIGS. 2a-2c.

FIG. 5a depicts a top view of a passive radio-frequency identification tag employing the core illustrated in FIGS. 3a-3c.

FIG. 5b depicts a side view of a passive radio-frequency identification tag employing the core illustrated in FIGS. 3a-3c.

FIG. 5c depicts an end view of a passive radio-frequency identification tag employing the core illustrated in FIGS. 3a-3c.

### DETAILED DESCRIPTION OF EXEMPLARY EMBODIMENTS

The following discussion is presented to enable a person skilled in the art to make and use the present teachings. Various modifications to the illustrated embodiments will be readily apparent to those skilled in the art, and the generic principles herein may be applied to other embodiments and applications without departing from the present teachings. Thus, the present teachings are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of the present teachings. Skilled artisans will recognize the examples provided herein have many useful alternatives and fall within the scope of the present teachings.

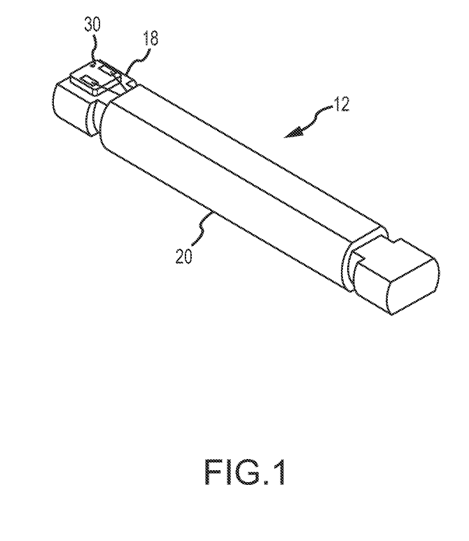

FIG. 1 illustrates an isometric elevated view of components of an implantable passive radio-frequency identification (“RFID”) tag or passive integrated transponder (“PIT”) tag according to various embodiments of the invention. The illustrated components include antenna core 12 with antenna coil 20, and surface 18 on which integrated circuit 30 is mounted. Generally, the antenna core 12 can be ferrite or similar material with high magnetic permeability and can take a variety of shapes that include being rectangular, planar, circular, or semi-circular along the length of the core. Antenna coil 20 is used for receiving and transmitting a modulated signal from an RFID reader. Functionally, integrated circuit 30 modulates and demodulates radio-frequency (RF) signals transmitted and/or received through antenna coil 20, generates power from the RF signals, and stores and processes information. As used herein, the term ‘integrated circuit’ describes a miniaturized electronic component formed using art-recognized methods. For example, integrated circuit 30 may include electronic circuitry fabricated on a silicon substrate. Antenna core 12, antenna coil 20, and integrated circuit 30 may be employed in an implantable RFID tag encapsulated by glass, ceramic, plastic, or other suitable art-recognized encapsulating material.

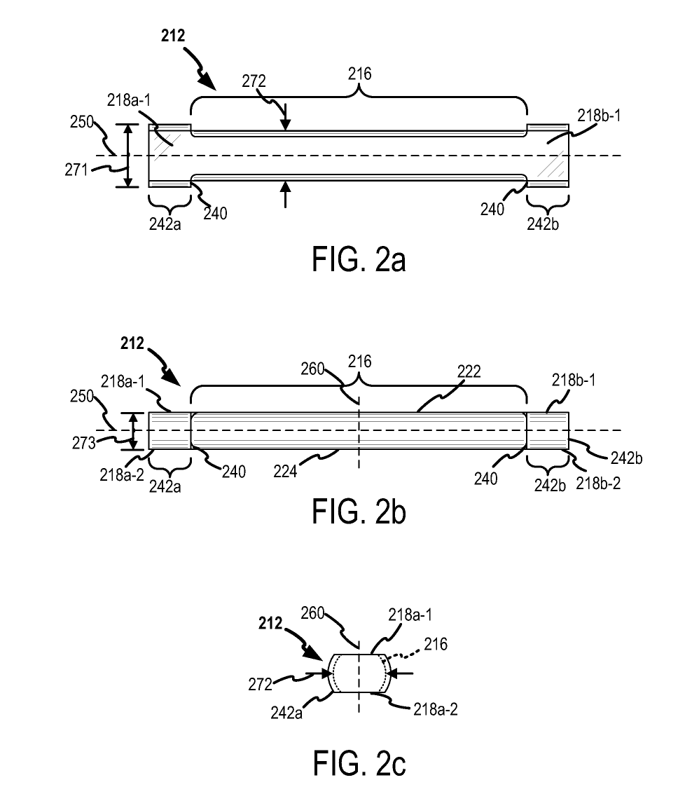

An antenna core 212 for a passive RFID tag is illustrated in FIGS. 2a-2c according to various embodiments. As shown in the top view in FIG. 2a, antenna core 212 generally comprises an elongated structure along longitudinal axis 250. Antenna core 212 generally includes a central section 216 and end sections 242. Central section 216 may have beveled ends 240 leading to end sections 242. Central section 216 is generally used to install antenna coil 20 on antenna core 212. The side view of antenna core 212 shown in FIG. 2b illustrates that antenna core 212 has surfaces 218a-1 and 218a-2 on the top and bottom of end section 242a and surfaces 218b-1 and 218b-2 on the top and bottom of end section 242b. Surfaces 218a-1, 218a-2, 218b-1, and 218b-2 are substantially planar areas of antenna core 212 for mounting integrated circuit 30 and/or other electronic components. In this regard, antenna coil 20 and integrated circuit 30 are not constrained to be mounted on a particular side or end of antenna core 212. Typically, integrated circuit 30 will be mounted on one of the substantially planar surfaces 218a-1, 218a-2, 218b-1, or 218b-2 using glue or epoxy. As also illustrated in FIG. 2b, antenna core 212 is symmetric about vertical axis 260, meaning that end sections 242a and 242b are substantially equal in length along longitudinal axis 250 of the core.

As shown in the end view of antenna core 212 shown in FIG. 2c, center section 216 and end sections 242a, 242b have substantially planar top and bottom surfaces and arcuate sides. In the present embodiment center section 216 and end sections 242a, 242b have sides that form circular arcs. The inventors have found that rounding the sides of end sections 242a, 242b and center section 216 increases the amount of ferrite material in antenna core 212 by about 15% over a core with a rectangular cross-section along the length of the core. Increasing the amount of ferrite material in antenna core 212 increases the operational range of RFID tags using antenna core 212. For example, the inventors have found that antenna core 212 increases the operational range of RFID tags by 10-15% over prior art cores.

Antenna core 212 has the ability to mount the antenna coil 20 and integrated circuit 30 in any orientation on antenna core 212. This simplifies the manufacturing process because antenna core 212 does not need to be oriented in a particular direction for installing the antenna coil 20 and integrated circuit 30. Specifically, in an automated manufacturing process for installing antenna coil 20 and integrated circuit 30 on antenna core 212, the core may be oriented only by longitudinal axis 250 and either the top 222 or bottom 224 flattened side of the core. For example, an automated manufacturing machine may receive antenna core 212 into an elongated carrier for handling during the manufacturing process. Because the top and bottom of antenna core 212 are flattened, the core will self-orient such that one of the top 222 or bottom 224 is facing up. For example, antenna core 212 may be oriented in the carrier such that the bottom 224 is facing up. In this orientation, the automated manufacturing machine may attach the antenna coil 20 to antenna core 212 such that the leads of the antenna coil are present at either end 242a or 242b. With either antenna coil arrangement, the automated manufacturing machine may attach the integrated circuit on whichever of surfaces 218a-1, 218a-2, 218b-1, or 218b-2 is proximate to the leads of the installed antenna coil 20. For example, if the automated manufacturing machine installs the antenna coil 20 so that the leads are present at the bottom side 224 and end 242b of the antenna core 212, the automated manufacturing machine may install the integrated circuit on integrated circuit mounting surface 218b-2.

In one embodiment of antenna core 212, center section 216 is 8 mm long and end sections 242a and 242b are each 1 mm in length, giving antenna core 212 an overall length of 10 mm. In this embodiment, end sections 242a and 242b have a diameter 271 of 1.51 mm and center section 216 has a diameter 272 of 1.2 mm. Also in this embodiment, antenna core 212 has a height 273 of 0.85 mm.

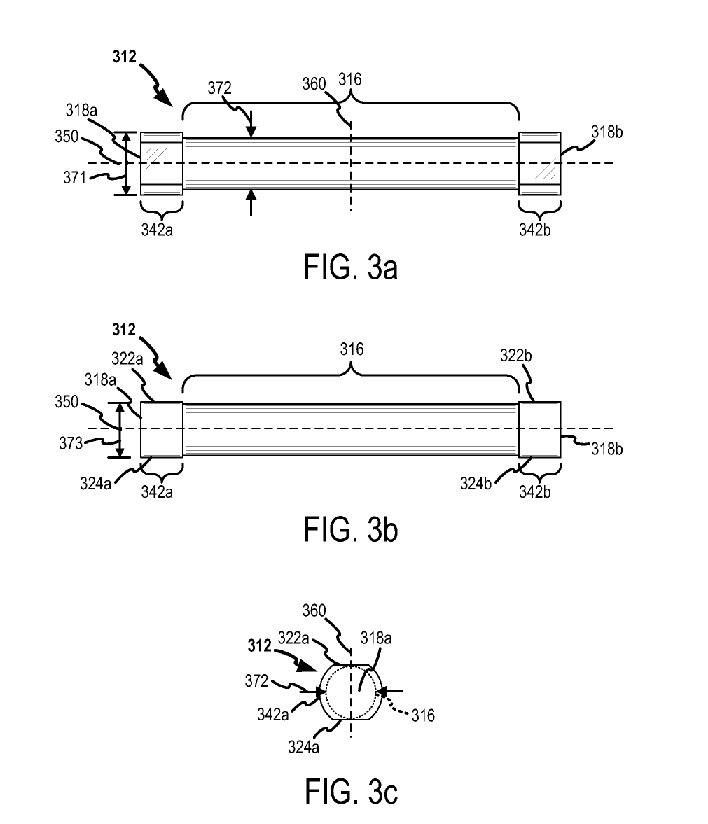

An alternative example of an antenna core 312 for a passive RFID tag is illustrated in FIGS. 3a-3c. As shown in the top view in FIG. 3a, antenna core 312 generally comprises an elongated structure along longitudinal axis 350. Antenna core 312 generally includes center section 316 and end sections 342a and 342b. The side view of antenna core 312 shown in FIG. 3b illustrates that antenna core 312 has substantially planar surfaces 318 on the end faces of end sections 342a and 342b orthogonal to longitudinal axis 250. That is, in this embodiment, the integrated circuit is mounted on one of the end faces of the antenna core and parallel to the extreme sides of antenna core 312. As also illustrated in FIG. 3b, antenna core 312 is symmetric about vertical axis 360, meaning that end sections 342a and 342b are equal in length.

As shown in the end view of antenna core 312 in FIG. 3c, in the present embodiment center section 316 of antenna core 312 has a circular cross-section. However, center section 316 of antenna core 312 could have a truncated circular cross-section similar to center section 216 of antenna core 212. As also shown in FIG. 3c, the end sections 342a and 342b of antenna core 312 have sides that are more rounded off than the sides of end sections 242a and 242b of antenna core 212. The inventors have found that the circular cross-section of antenna coil mounting section 316 and more rounded cross-section of end sections 342a and 342b increases the amount of ferrite material in antenna core 312 by approximately 10% over antenna core 212. Thus, antenna core 312 again increases the operational range of RFID tags using this core structure.

The flattened sections of end sections 342a and 342b, shown by substantially planar top sides 322a and 322b and bottom sides 324a and 324b, ensure that the antenna core 312 does not rotate during handling in automated manufacturing equipment. In particular, while integrated circuit 30 may be installed in either direction relative to the top 322a, 322b or bottom 324a, 324b of the core, it may be useful to maintain the relative positioning between the antenna coil 20 and the integrated circuit 30 during the manufacturing process. For example, antenna core 312 may be received by a carrier in an automated manufacturing machine for installation of antenna coil 20 and integrated circuit 30. Antenna core 312 may be received in the carrier in any rotational orientation relative to longitudinal axis 350 and the flattened top 322a, 322b and bottom 324a, 324b will cause antenna core 312 to self-align such that one of the top 322a, 322b or bottom 324a, 324b is facing up in the carrier. For example, antenna core 312 may orient in the carrier such that bottom sides 324a and 324b are facing up. In this orientation, the automated manufacturing machine may attach the antenna coil 20 to antenna core 312 such that the leads of the antenna coil are present at either end 342a or 342b. With either antenna coil arrangement, the automated manufacturing machine may attach the integrated circuit on the integrated circuit mounting surface 318a or 318b that is proximate to the leads of the installed antenna coil 20. For example, if the automated manufacturing machine installs the antenna coil 20 so that the leads are present at the bottom side 324b of end 342b of antenna core 312, the automated manufacturing machine may install integrated circuit 30 on integrated circuit mounting surface 318b with a first side of integrated circuit 30 proximate to the bottom side 324b. Conversely, if top sides 322a and 322b are facing up and the automated manufacturing machine attaches the antenna coil 20 to antenna core 312 so that the leads are present at the top side 322b of end 342b of antenna core 312, the automated manufacturing machine may install the integrated circuit on integrated circuit mounting surface 318b with the first side of the integrated circuit proximate to the top side 322b. Notably, once the automated manufacturing machine has attached the antenna coil on center section 316, antenna core 312 will stay in a fixed orientation in the automated manufacturing machine because of the flattened top 322a, 322b and bottom 324a, 324b areas of end sections 342a and 342b. Therefore, antenna core 312 avoids the problem of the core rotating during manufacturing such that the leads of antenna coil 20 are not in position to be attached to the bond pads of integrated circuit 30.

In one embodiment of antenna core 312, antenna coil mounting section 316 is 8 mm long and end sections 342a and 342b are each 1 mm in length, giving antenna core 312 an overall length of 10 mm. In this embodiment, end sections 342a and 342b have a diameter 371 of 1.51 mm and antenna coil section 216 has a diameter 372 of 1.2 mm. Also in this embodiment, antenna core 312 has a height 373 of 1.31 mm.

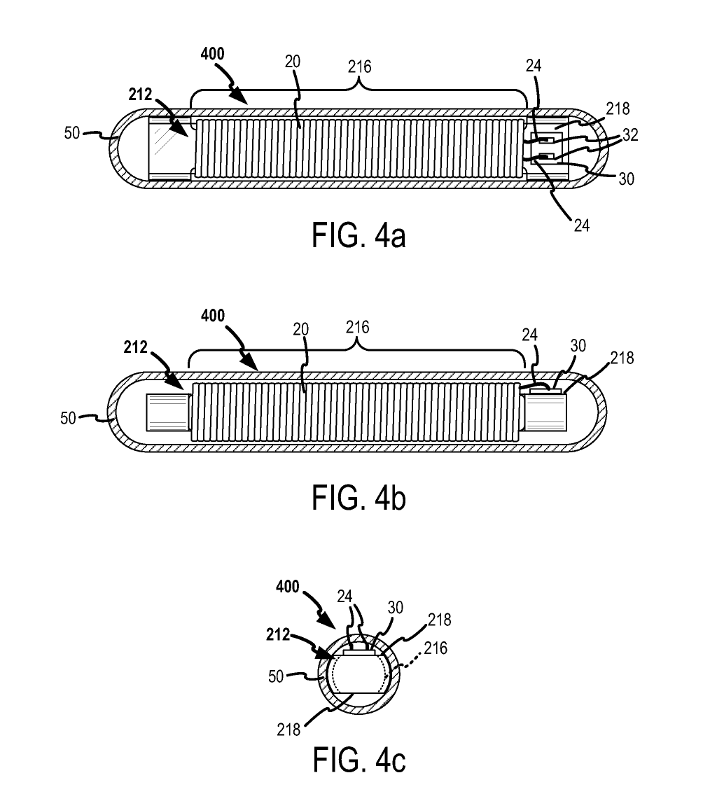

FIGS. 4a-4c depict an encapsulated passive RFID tag 400 employing antenna core 212 according to various embodiments. As shown in FIG. 4a, antenna coil 20 is mounted on center section 216 and integrated circuit 30 is mounted on surface 218. As can be seen in FIGS. 4a and 4b, antenna core 212 extends substantially the entire length of RFID tag 400. In this regard, antenna core 212 is a unitary or one-piece magnetic core.

As described above, surface 218 of FIGS. 4a-4c may be any one of surfaces 218a-1, 218a-2, 218b-1, and 218b-2 of antenna core 212 shown in FIG. 2b. As illustrated in FIG. 4a, leads 24 of antenna coil 20 are attached to bond pads 32 of integrated circuit 30. In this regard, antenna coil 20 is directly connected to integrated circuit 30. Leads 24 may be attached using an art recognized method of attaching leads to integrated circuit bond pads. For example, leads 24 may be attached to bond pads 32 using thermal-compression bonding. Antenna core 212, antenna coil 20, and integrated circuit 30 are encapsulated by encapsulant 50 to create implantable passive RFID tag 400.

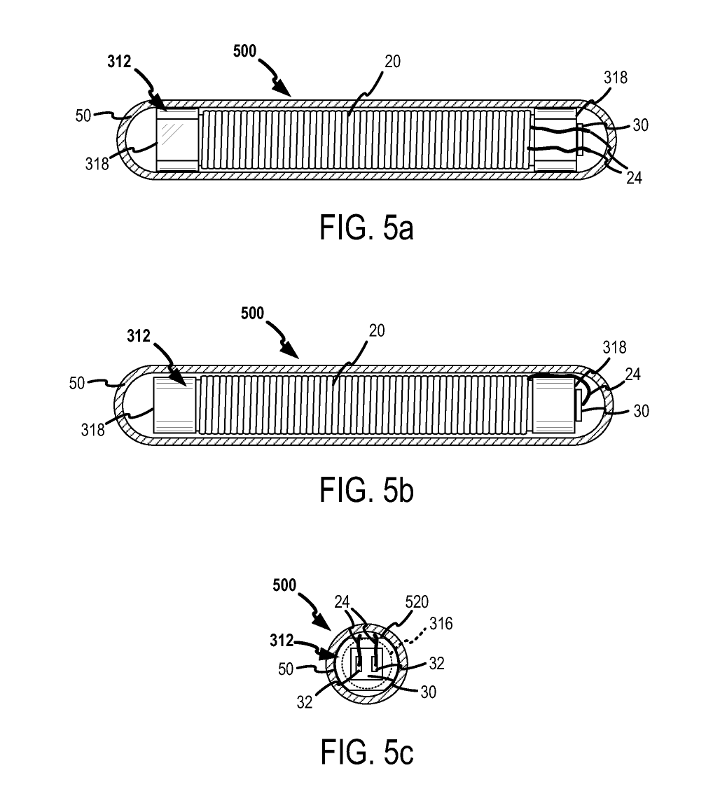

FIGS. 5a-5c depict an encapsulated passive RFID tag 500 employing antenna core 312 according to various embodiments. As shown in FIG. 5a, antenna coil 20 is mounted on antenna coil mounting section 316 and integrated circuit 30 is mounted on surface 318. As can be seen in FIGS. 5a and 5b, antenna core 312 extends substantially the entire length of RFID tag 500. In this regard, antenna core 312 is a unitary or one-piece magnetic core.

As described above, surface 318 may be either one of surfaces 318a and 318b of antenna core 312 shown in FIG. 3b. Additionally, surface 520 in FIG. 5c may be the top 322a or the bottom 324a of end section 342a, or the top 322b or the bottom 324b of end section 342b shown in FIG. 3b. As illustrated in FIG. 5c, leads 24 of antenna coil 20 are attached to bond pads 32 of integrated circuit 30. In this regard, antenna coil 20 is directly connected to integrated circuit 30. Leads 24 may be attached using an art recognized method of attaching leads to integrated circuit bond pads. For example, leads 24 may be attached to bond pads 32 using thermal-compression bonding. Antenna core 312, antenna coil 20, and integrated circuit 30 are encapsulated by encapsulant 50 to create implantable passive RFID tag 500.

Implantable passive RFID tags 400 and 500 are usually in the range of 12-14 mm long, but possibly in the range of 8-10 mm long, and possibly in the range of 4-5 mm long. RFID tags 400 and 500 are usually 2-10 mm in diameter, but possibly within the range of 2-7 mm in diameter, and possibly in the range of 1-5 mm in diameter. RFID tags 400 and 500 may be operated at frequencies between 125 KHz and 134.2 KHz, used generally for identifying companion animals, fish, wildlife, and slaughter animals.

The foregoing embodiments and accompanying description have been presented for purposes of illustration. While a number of exemplary aspects and embodiments have been discussed above, the description is not intended to limit embodiments of the present invention to the form disclosed herein. Those of skill in the art will recognize variations, modifications, additions, and sub-combinations thereof.

What is claimed is:

1. A passive radio-frequency identification tag, comprising:
a magnetic core having a longitudinal axis, the magnetic core elongated along the longitudinal axis and comprising:
a first end section at one end of the magnetic core,
a central section, and
a second end section at an opposite end of the magnetic core from the first end section, the first and second end sections having substantially equal lengths along the longitudinal axis of the magnetic core and greater cross-sectional area than a cross-sectional area of the central section, wherein the first and second end sections each have arcuate sides and substantially planar top and bottom surfaces;
an integrated circuit disposed on one of the top or the bottom surfaces of one of the first or second end sections; and
an antenna coil disposed around the central section and coupled to the integrated circuit.

2. The passive radio-frequency identification tag of claim 1, wherein the central section has substantially planar top and bottom surfaces and arcuate sides.

3. The passive radio-frequency identification tag of claim 1, wherein the arcuate sides of the first and second end sections comprise circular arcs.

4. The passive radio-frequency identification tag of claim 3, wherein the arcuate sides of the central section comprise circular arcs.

5. The passive radio-frequency identification tag of claim 1, wherein the magnetic core comprises ferrite.

6. The passive radio-frequency identification tag of claim 1, wherein the magnetic core comprises high-temperature ferrite.

7. The passive radio-frequency identification tag of claim 1, wherein leads of the antenna coil are directly connected to the integrated circuit.

8. The passive radio-frequency identification tag of claim 1, wherein leads of the antenna coil are bonded to the integrated circuit using thermal-compression bonding.

9. The passive radio-frequency identification tag of claim 1, wherein a height of the magnetic core is substantially uniform along the longitudinal axis of the core.

10. The passive radio-frequency identification tag of claim 1, wherein the integrated circuit is attached to the one of the top or bottom surfaces of the one of the first or second end sections using an epoxy.

11. The passive radio-frequency identification tag of claim 1, further comprising an encapsulation housing that surrounds the magnetic core.

12. The passive radio-frequency identification tag of claim 11, wherein the encapsulation housing comprises a glass encapsulation housing.

13. A passive radio frequency identification tag, comprising:
a magnetic core having a longitudinal axis, the magnetic core elongated along the longitudinal axis and symmetric about a vertical axis passing through a center of the magnetic core and orthogonal to the longitudinal axis, the magnetic core comprising a central section and first and second end sections having greater cross-sectional area than the central section, wherein the first and second end sections each have arcuate sides and substantially planar top and bottom surfaces;
an integrated circuit disposed on one of the top or bottom surfaces of one of the first or second end sections; and
an antenna coil formed around the central section and electrically coupled to the integrated circuit.

14. The passive radio-frequency identification tag of claim 13, wherein the first and second end sections each have substantially planar surfaces at the ends of the magnetic core and orthogonal to the longitudinal axis.

15. A passive radio-frequency identification tag, comprising:
a magnetic core having a longitudinal axis, the magnetic core elongated along the longitudinal axis and comprising:
a first end section at one end of the magnetic core,
a central section, and
a second end section at an opposite end of the magnetic core from the first end section, the first and second end sections having substantially equal lengths along the longitudinal axis of the magnetic core and greater cross-sectional area than a cross-sectional area of the central section, wherein the first and second end sections each have substantially planar surfaces at the ends of the magnetic core and orthogonal to the longitudinal axis;
an integrated circuit disposed on one of the substantially planer surfaces of the first and second end sections; and
an antenna coil formed around the central section and electrically coupled to the integrated circuit.

16. The passive radio-frequency identification tag of claim 15, wherein the central section has substantially planar top and bottom surfaces and arcuate sides.

17. The passive radio-frequency identification tag of claim 15, wherein the central section of the magnetic core has a circular cross-section.

18. The passive radio-frequency identification tag of claim 15, wherein the first and second end sections have substantially planar top and bottom surfaces and arcuate sides.
